(19) United States
(12) Patent Application Publication
(10) Pub. No.: US 2008/0296355 A1
(43) Pub. Date: Dec. 4, 2008

(54) Direct ball dispenser

(75) Inventors: Rene Oriendo Costales, Baguio City (PH); Ma. Alessandra K. Yap Azurin, Paranaque (PH); Rey Manglallan Balaoing, Baguio City (PH)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/809,314

(22) Filed: May 31, 2007

(51) Int. Cl. B23K 35/14; B23K 1/00; B23Q 16/00

(52) U.S. Cl. 228/246; 228/41; 228/8

(57) ABSTRACT

In a method and apparatus for dispensing solder balls, a container having an opening for dispensing solder balls is positioned to enable a flow of the solder balls through the opening. The solder balls have a common configurable solder ball diameter. A proximal opening of a tube is coupled to the opening of the container. A distal opening of the tube is coupled to a nozzle. The nozzle has a nozzle orifice that is configured in accordance with the solder ball diameter to dispense the solder balls into a ball bin. A hopper vibrator is coupled to the nozzle to impart vibration energy to the nozzle, thereby providing a stimulus to the flow. A tool head picks selected ones of the solder balls from the ball bin for an assembly of a semiconductor device.

### BACKGROUND

The present invention is related in general to the field of semiconductor device assembly and packaging, and more specifically to an apparatus and method for assembling an integrated circuit (IC) package using solder balls.

The use of unfused solid filler such as solder balls (may also be referred to as solder bumps or conductive bumps) for attaching the IC chip to a substrate of a semiconductor device using metal fusion bonding is well known. The solder balls, which are often laid out in a ball grid array (BGA), are reflowed to provide electrical and mechanical coupling between the IC chip and the substrate. Solder balls may also be used in flip chip (FC) packages. The size of the solder balls may vary with the type of IC package. For example, a diameter of a solder ball may vary from about 50 micrometers to about 800 micrometers.

FIG. 1 illustrates a traditional solder ball dispenser 100, according to prior art. Solder balls 110 may be considered as discrete bulk commodity products that are typically packaged and delivered in a sealed bottle 112. Depending on the supplier, the bottle 112 is generally cylindrical in shape and is often made of glass or plastic material. Each bottle may include hundreds of thousands or several million units of the solder balls 110. Each solder ball contained in the sealed bottle 112 is generally in compliance with a particular set of desired attributes such as solder ball diameter, solder ball material, reflow temperature, and similar others. Solder balls 110 having a common attribute such as size are manually loaded by opening and emptying out the sealed bottle 112 on to a ball hopper 120 that is coupled to a hopper vibrator 130. The hopper vibrator 130 delivers vibration energy, e.g., using ultrasonics, to the solder balls 110, thereby enabling the solder balls 110 to be dropped in to a ball bin 140. A plastic enclosure 132 is provided to contain the movement of the solder balls 110 during the operation of the hopper vibrator 130. Some solder balls may not be collected in the ball bin 140 and may be scattered elsewhere. A tool head 150 is operable to pick up selected ones of the solder balls 110 from the ball pin 140, e.g., by using suction or vacuum, for placement of the selected ones on to a conductive pad of a substrate (not shown). If solder balls having a different size is desired to fabricate an IC package, then all existing ones of the solder balls 110 are typically removed and discarded as scrap. Thus, the traditional solder ball dispenser 100 is often not able to regulate a flow of the solder balls 110 in to the ball bin 140 and is often inefficient in being able to handle IC packages having solder balls of different diameters.

### SUMMARY

Applicants recognize an existing need for an apparatus and method for efficiently dispensing solder balls on a regulated basis, absent the disadvantages found in the prior art techniques discussed above. Applicants also recognize an existing need for the improved apparatus and method to provide: 1) dispensing of solder balls having a desired attribute on an on-demand basis, thereby facilitating switching of solder balls having different attributes, 2) saving of unused solder balls for future use, thereby improving efficiency and reducing wastage, 3) dispensing of the solder balls on a first-in-first-out (FIFO) basis, thereby enabling timely utilization of the solder balls, 4) controlled flow of the solder balls by forming a linear supply chain, and 5) compatibility with legacy assembly line components including the ball bin.

The foregoing need is addressed by the teachings of the present disclosure, which relates to an apparatus and method for assembly and packaging of semiconductor devices. According to one embodiment, in a method and apparatus for dispensing solder balls, a container having an opening for dispensing solder balls is positioned to enable a flow of the solder balls through the opening. The solder balls have a common configurable solder ball diameter. A proximal opening of a tube is coupled to the opening of the container. A distal opening of the tube is coupled to a nozzle. The nozzle has a nozzle orifice that is configured in accordance with the solder ball diameter to dispense the solder balls into a ball bin. A hopper vibrator is coupled to the nozzle to impart vibration energy to the nozzle, thereby providing a stimulus to the flow. A tool head picks selected ones of the solder balls from the ball bin for an assembly of a semiconductor device.

In one aspect of the disclosure, a method for dispensing solder balls includes positioning a container to enable a gravity-assisted flow of solder balls through an opening of the container. The container contains the solder balls having a common configurable solder ball diameter. A proximal end of a tube is coupled to the opening and a distal end of the tube is coupled to a nozzle. An inclination angle of the nozzle and an orifice of the nozzle is adjusted to regulate the flow of the solder balls.

Several advantages are achieved by the method and apparatus according to the illustrative embodiments presented herein. The embodiments advantageously provide an improved apparatus and method for dispensing solder balls used in the fabrication of semiconductor devices. The improved apparatus and method advantageously dispenses solder balls having desired attributes, such as a desired diameter or a desired material or both on an on-demand basis, based on the production needs. Switching between solder balls having different attributes is enabled by switching containers containing the desired solder balls. Unused solder balls are advantageously retained in the container for future use, thereby advantageously protecting the solder balls from being exposed to the environment. The retention of the unused solder balls in the container improves production efficiency by reducing wastage, The dispensing of the solder balls advantageously occurs in a first-in-first-out (FIFO) sequence, thereby enabling timely utilization of the solder balls. That is, solder balls dispensed in the ball bin are utilized prior to the utilization of the solder balls still being dispensed through the nozzle. A controlled flow of the solder balls is advantageously achieved by balancing incoming flow of the solder balls through the tube and outgoing flow of the solder balls being placed by the pick-and-place machine to assemble the semiconductor device. The improved apparatus and method advantageously maintains compatibility with legacy the assembly line components by using the ball bin and the tool head of the legacy assembly line.

### BRIEF DESCRIPTION OF THE DRAWINGS

FIG. 1 illustrates a traditional solder ball dispenser, described herein above, according to prior art;

FIG. 2A illustrates a simplified and schematic diagram of an apparatus for dispensing solder balls, according to an embodiment;

FIG. 2B is a schematic diagram of a container described with reference to FIG. 2A illustrating a loading position, according to an embodiment;

FIG. 2C is a schematic diagram of a container described with reference to FIG. 2A illustrating a dispensing position, according to an embodiment;

FIG. 2D is a schematic diagram illustrating additional detail of a container described with reference to FIG. 2A, according to an embodiment;

FIG. 3A is a flow chart illustrating a method for dispensing solder balls, according to an embodiment; and

FIG. 3B is a flow chart illustrating a method for replacing a container described with reference to FIG. 3A, according to an embodiment.

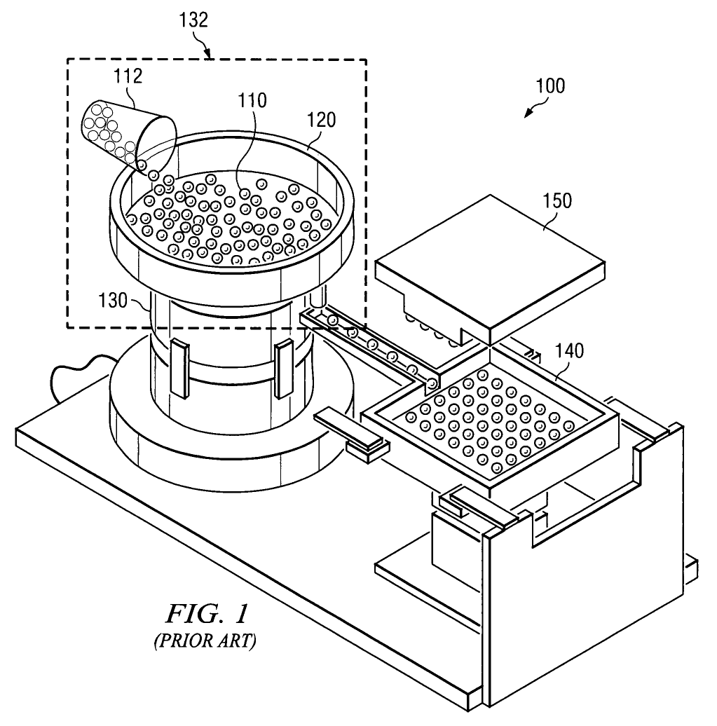

### DETAILED DESCRIPTION

Novel features believed characteristic of the present disclosure are set forth in the appended claims. The disclosure itself, however, as well as a preferred mode of use, various objectives and advantages thereof, will best be understood by reference to the following detailed description of an illustrative embodiment when read in conjunction with the accompanying drawings. The functionality of various circuits, devices or components described herein may be implemented as hardware (including discrete components, integrated circuits and systems-on-a-chip ‘SoC’), firmware (including application specific integrated circuits and programmable chips) and/or software or a combination thereof, depending on the application requirements.

Similarly, the functionality of various mechanical elements, members, or components for forming modules, sub-assemblies and assemblies assembled in accordance with a structure for an apparatus may be implemented using various materials and coupling techniques, depending on the application requirements. Descriptive and directional terms used in the written description such as top, bottom, left, right, and similar others, refer to the drawings themselves as laid out on the paper and not to physical limitations of the disclosure unless specifically noted. The accompanying drawings may not to be drawn to scale and some features of embodiments shown and described herein may be simplified or exaggerated for illustrating the principles, features, and advantages of the disclosure.

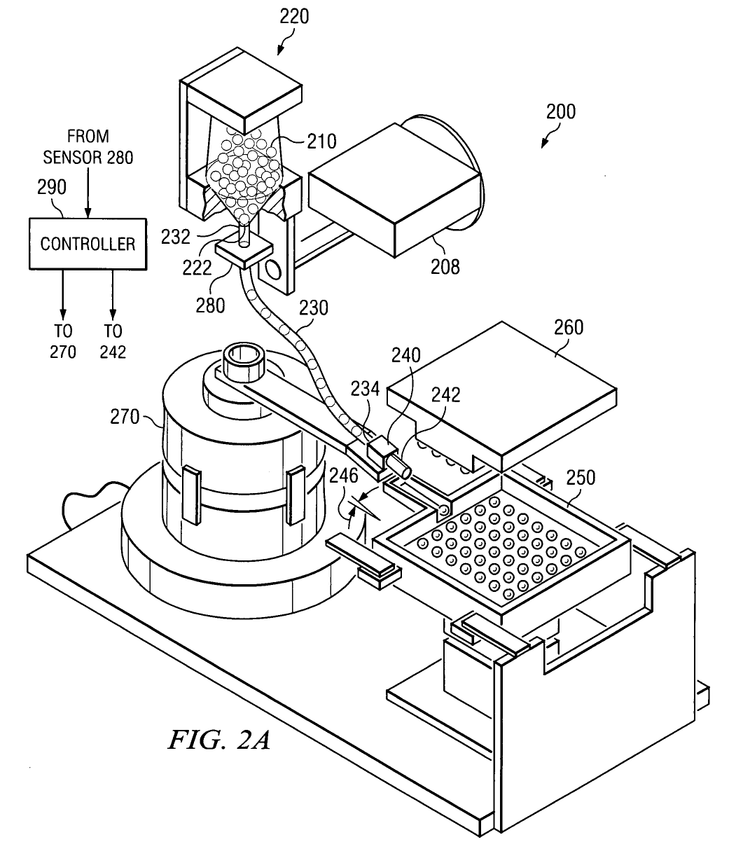

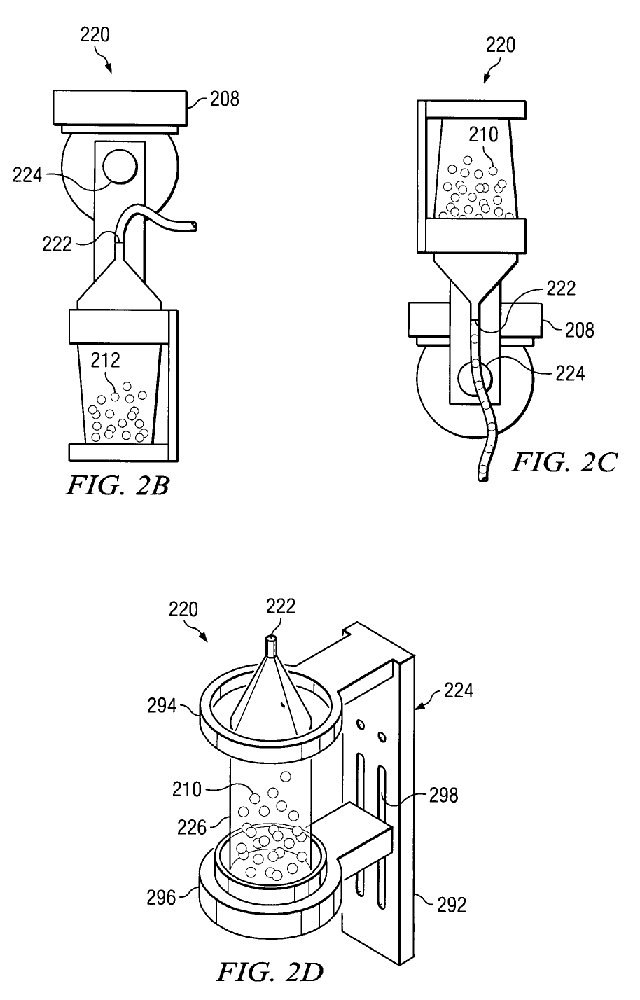

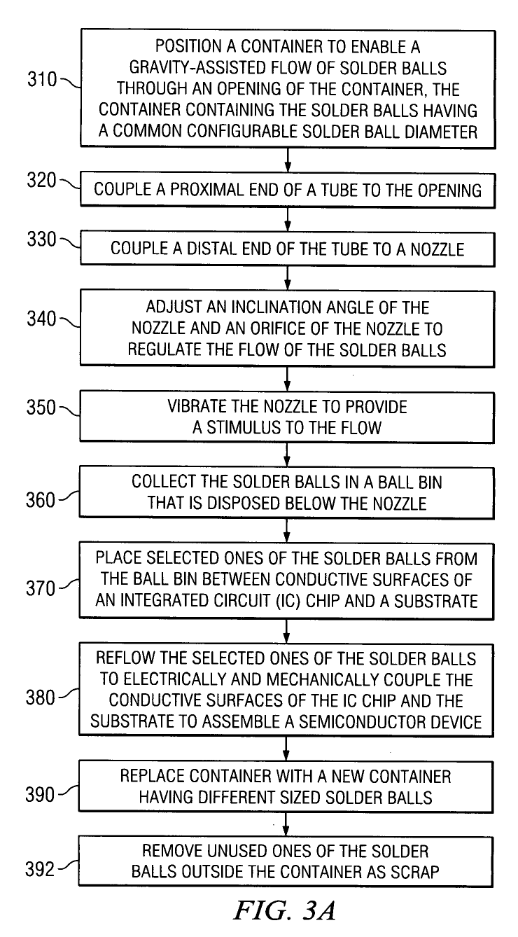

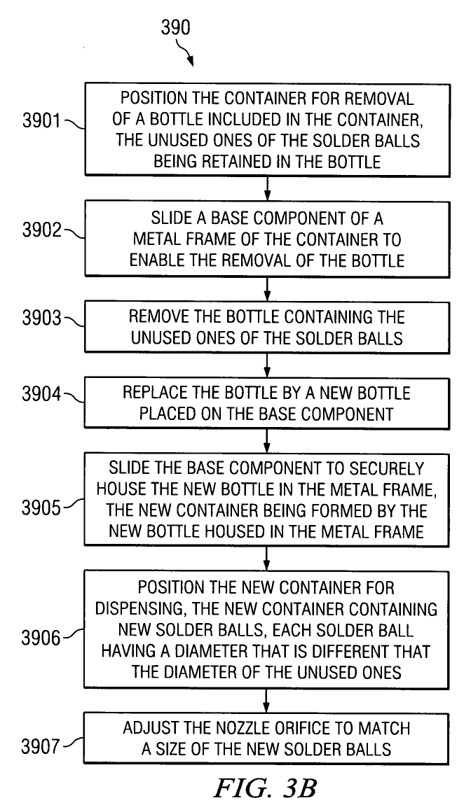

Many semiconductor devices utilize solder balls having different attributes such as size and material. Traditional solder ball dispensers used in the assembly operations of semiconductor device manufacturers are often not able to regulate a flow of the solder balls and are often inefficient in being able to handle IC packages having solder balls of different sizes. Thus, a switchover or conversion from one type or size of solder ball to another is inefficient, costly and time consuming. These problems, among others, may be addressed by an apparatus and method for fabricating a semiconductor device using an improved solder ball dispenser. According to an embodiment, in a method and apparatus for dispensing solder balls, a container having an opening for dispensing solder balls is positioned to enable a flow of the solder balls through the opening. The solder balls have a common configurable solder ball diameter. A proximal opening of a tube is coupled to the opening of the container. A distal opening of the tube is coupled to a nozzle. The nozzle has a nozzle orifice that is configured in accordance with the solder ball diameter to dispense the solder balls into a ball bin. A hopper vibrator is coupled to the nozzle to impart vibration energy to the nozzle, thereby providing a stimulus to the flow. A tool head picks selected ones of the solder balls from the ball bin for an assembly of a semiconductor device. An apparatus for efficiently dispensing solder balls used in the fabrication of semiconductor devices is described with reference to FIGS. 2A, 2B, 2C, 2D, 3A and FIG. 3B.

The following terminology may be useful in understanding the present disclosure. It is to be understood that the terminology described herein is for the purpose of description and should not be regarded as limiting.

Semiconductor Package (or Package)—A semiconductor package provides the physical and electrical interface to at least one integrated circuit (IC) or die for connecting the IC to external circuits. The package protects the IC from damage, contamination, and stress that result from factors such as handling, heating, and cooling. The process of putting the IC inside a package to make it reliable and convenient to use is known as semiconductor package assembly, or simply ‘assembly’.

Semiconductor Device—A semiconductor device is an electronic component that utilizes electronic properties of semiconductor materials to perform a desired function. A semiconductor device may be manufactured as a single discrete device or as one or more ICs packaged into a module.

Solder Ball—A solder is a fusible metal alloy, which may be melted to fuse two metallic surfaces. The solder material may also be described as an unfused solid filler that is used for metal fusion bonding. Solder in the form of tiny spheres or balls are often laid out in a ball grid array (BGA) and reflowed to form an electrical and mechanical contact between an IC and a substrate of a semiconductor device. A solder ball may also be referred to as a solder bump or a conductive bump. A type of a solder ball desired for a particular application may be specified in terms of the solder ball attributes (or properties) such as diameter, tolerance, alloy material, reflow temperature range, order quantity, and similar others. Thus, a solder ball when fused or reflowed is a type of an electrical interconnect, which provides electrical coupling between two electrical elements.

Substrate—A substrate is an underlying material used to fabricate a semiconductor device. In addition to providing base support, substrates are also used to provide electrical interconnections between the IC chip and external circuits. Two categories of substrates that are used to fabricate the semiconductor device include rigid substrates and flexible tape substrates. Rigid substrates are typically composed of a stack of thin layers or laminates, and are often referred to as multilayer laminate substrates. In some applications, the laminate substrate may include a single layer of dielectric material and a single layer of metal. Flexible tape substrates are typically composed of polymer material such as polyimide, and are often referred to as a polyimide tape substrate. The polyimide tape substrate, which typically includes a metal layer, is generally cheaper, thinner and more flexible compared to the multilayer laminate substrate. Interconnecting patterns such as vias provide electrical coupling between the multiple layers of the substrate. The conductive layers typically include traces of a metal foil bonded to a polymer substrate.

Ball grid array (BGA)—A type of chip package type that enables direct mounting of the chip to a substrate or printed circuit board via solder balls or bumps. The solder balls or bumps are arranged in a grid-style array and found on the underside of the chip to make the electrical connection to the outside.

Configuration—Describes a set up of an element, a circuit, a package, an electronic device, and similar other, and refers to a process for setting, defining, or selecting particular properties, parameters, or attributes of the device prior to or during its use or operation. Some configuration attributes may be selected to have a default value. For example, for a particular assembly application, a solder ball may be configured to have a diameter of 100 micrometers.

FIG. 2A illustrates a simplified and schematic diagram of an apparatus 200 for dispensing solder balls 210, according to an embodiment. The apparatus 200 includes a container 220 containing the solder balls 210. The container 220 includes an opening 222 for dispensing the solder balls 210. A positioner 208, which is coupled to the container 220, is capable of adjusting the position of the container 220 to enable or disable the gravity-assisted dispensing. Additional detail of the container 220 is described with reference to FIGS. 2B, 2C, and 2D. A flexible enclosed supply line is provided for sequentially transferring the solder balls 210 from the container 220 to a ball bin 250.

The flexible enclosed supply line includes a tube 230 having a proximal opening 232 and a distal opening 234. The distal opening 234 is removably coupled, e.g., coupled in a removable manner, to a nozzle 240 having a nozzle orifice 242. The proximal opening 232 is removably coupled to the opening 222 of the container 220, thereby enabling the solder balls 210 to be dispensed from the container 220 into the tube 230. A size of the nozzle orifice 242 is configurable in accordance with the solder ball diameter to dispense the solder balls 210 at a desired flow rate. The solder balls 210 are dispensed by the nozzle 240 through the nozzle orifice 242 in a first-in-first-out (FIFO) sequence, thereby enabling timely utilization of the solder balls 210. That is, solder balls dispensed in the ball bin 250 are utilized prior to the utilization of the solder balls 210 still being dispensed through the container 220. The nozzle 240 is positioned so that the solder balls 210 that are dispensed by the nozzle 240 are advantageously collected in the ball bin 250 without being scattered elsewhere.

A tool head 260, which is a part of a pick-and-place machine (not shown), is operable to pick selected ones of the solder balls 210 from the ball bin 250 and place them on conductive pads for further assembly of a semiconductor device (not shown). In an exemplary, non-depicted embodiment, the semiconductor device is at least one of a microprocessor, an application specific integrated circuit (ASIC), a digital signal processor, a radio frequency chip, a memory, a microcontroller and a system-on-a-chip or a combination thereof.

A hopper vibrator 270 is mechanically coupled to the nozzle 240 by a metal stem. The hopper vibrator 270 is operable to convert electrical energy to vibration energy, a form of mechanical energy. The vibration energy is imparted to the nozzle 240 via the stem and hence to the solder balls 210 contained in the nozzle 240. Thus, the hopper vibrator 270 provides a stimulus to the flow of the solder balls 210 that are dispensed through the nozzle 240. In an embodiment, the container 220 and the tube 230 are fabricated from a clear plastic material, thereby improving visibility to the solder balls 210 contained there within.

The apparatus 200 includes a sensor 280 operable to detect a presence or an absence of the solder balls 210 in the tube 230. In a particular embodiment, the sensor 280 may be operable to measure a flow rate of the solder balls 210 flowing through the tube 230. A controller 290 is operable to manually or automatically control the operation of the apparatus 100. In the depicted embodiment, the controller 290 is coupled to the sensor 280 and the hopper vibrator 270. The controller 290 may be configured to disable the hopper vibrator 270 if the sensor 280 detects an alarm condition such as absence of the solder balls 210 in the tube 230.

In a particular embodiment, the flow rate of the solder balls 210 is adjusted by making an inclination angle 246 of the nozzle 240 to be approximately equal to 10 degrees, the inclination angle being formed between an axis of the nozzle 240 and a horizontal direction. In an exemplary, non-depicted embodiment, the flow rate is also controlled by adjusting the nozzle orifice 242. A size of the nozzle orifice 242 may be manually controlled or automatically controlled by the controller 290, e.g., by making the opening of the nozzle orifice 242 larger or smaller. In an embodiment, the rate of the flow of the solder balls 210 through the nozzle 240 is adjusted to be equal to a rate of removal of the solder balls 210 by the tool head 260 from the ball bin 250. The equalizing of the flow rate into the ball bin 250 and the flow rate out of the ball bin 250 advantageously avoids overfilling or under filling of the solder balls 210 in the ball bin 250, thereby improving the operation of the tool head 260.

FIG. 2B is a schematic diagram of the container 220 described with reference to FIG. 2A illustrating a loading position, according to an embodiment. FIG. 2C is a schematic diagram of the container 220 described with reference to FIG. 2A illustrating a dispensing position, according to an embodiment. Referring to FIG. 2B and FIG. 2C, the container 220 is capable of being placed in the loading position or the dispensing position by rotating the container 220 around a pivot 224 secured to the positioner 208. After being placed in one of the loading position or the dispensing position, the container 220 may be secured to avoid undesired rotation around the pivot 224. When the container 220 is positioned in the loading position, the gravity-assisted flow of the solder balls 210 through the opening 222 is disabled. Unused solder balls 212 are retained in the container 220. The loading position enables replacement or servicing of the container 220. That is, when the container 220 is positioned in the loading position, the container 220 containing the unused solder balls 212 may be safely removed and replaced by another container containing different solder balls. When the container 220 (or a new container containing new solder balls that are different than the replaced ones) is positioned in the dispensing position, the gravity-assisted flow of the solder balls 210 through the opening 222 is enabled.

FIG. 2D is a schematic diagram illustrating additional detail of the container 220 described with reference to FIG. 2A, according to an embodiment. The container 220, which is illustrated to be placed in the loading position, includes a metal frame 284 that is capable of removably housing a cylindrical shaped bottle 226 having a sealed lid top (not shown). The lid top may be removed to unseal the solder balls 210. The bottle 226 may be typically provided by a supplier as a discrete bulk commodity product. The bottle 226 is fabricated from glass or plastic, and contains a specified quantity of solder balls that are in compliance with a desired set of attributes such as ball size, material, reflow temperature range, and similar others. It is understood that the dimensions and the fabrication material of the bottle 226 may vary with each supplier. For example, the lid of the bottle 226 may have a slightly larger diameter compared to the base diameter. Thus, a replacement of the container 220 includes a replacement of the bottle 226, while the metal frame 284 advantageously houses various supplier-dependent bottle sizes.

The metal frame 284 includes a post 292, a circular funnel-shaped component 294, and a circular base component 296. The funnel-shaped component 294 and the base component 296 are oriented parallel to each other and are oriented perpendicular to the post 292. The base component 296 is slidably secured to the post 292 by two slots 298. That is, the base component 296 may be slid along the slots 298 to the lowest position to clear the top of the bottle 226 from the funnel-shaped component 294, thereby enabling the removal of the bottle 226. A new bottle may be positioned on the base component 226. The base component 226 may be slid along the slots 298 towards the funnel-shaped component 294, thereby enabling the new container to snugly fit with the funnel-shaped component 294. The metal frame 284 is secured to the positioner (not shown).

FIG. 3A is a flow chart illustrating a method for dispensing solder balls, according to an embodiment. In a particular embodiment, FIG. 3A illustrates the process for fabricating a semiconductor device using the apparatus 200 described with reference to FIGS. 2A, 2B, 2C, and 2D. At step 310, a container is positioned to enable a gravity-assisted flow of solder balls through an opening of the container, the container containing the solder balls having a common configurable solder ball diameter. At step 320, a proximal end of a tube is coupled to the opening. At step 330, a distal end of the tube is coupled to a nozzle. At step 340, an inclination angle of the nozzle and an orifice of the nozzle are adjusted to regulate the flow of the solder balls. At step 350, the nozzle is vibrated to provide a stimulus to the flow. At step 360, the solder balls are collected in a ball bin that is disposed below the nozzle. At step 370, selected ones of the solder balls from the ball bin are placed between conductive surfaces of an integrated circuit (IC) chip and a substrate. At step 380, the selected ones of the solder balls are reflowed to electrically and mechanically couple the conductive surfaces of the IC chip and the substrate to assemble a semiconductor device.

Various steps described above may be added, omitted, combined, altered, or performed in different orders. For example, two steps may be added after step 380 to include solder balls having a different size in the assembly of the semiconductor device. At step 390, the container is replaced by a new container, which contains the different sized solder balls. At step 392, unused ones of the solder balls that are located outside the container are removed as scrap.

FIG. 3B is a flow chart illustrating a method for replacing a container described with reference to step 390 of FIG. 3A, according to an embodiment. In a particular embodiment, FIG. 3B illustrates the process for replacing the container included in the apparatus 200 described with reference to FIGS. 2A, 2B, 2C, and 2D. At step 3901, the container is positioned for removal of a bottle included in the container, e.g., by placing the container in a loading position. The unused ones of the solder balls are retained in the bottle. At step 3902, a base component of a metal frame of the container is slid to enable the removal of the bottle. At step 3903, the bottle containing the unused ones of the solder balls is removed. At step 3904, the bottle is replaced by a new bottle placed on the base component. At step 3905, the base component is slid to securely house the new bottle in the metal frame, the new container being formed by the new bottle housed in the metal frame. At step 3906, the new container is positioned for dispensing, e.g., placed in a dispensing position. The new container contains new solder balls, each solder ball having a diameter that is different that the diameter of the unused ones. At step 3907, the nozzle orifice is adjusted to match a size of the new solder balls.

Various steps described above may be added, omitted, combined, altered, or performed in different orders. For example, if the container is replaced by an identical replacement container, step 3907 may be deleted since the size of the new solder balls is the same as the unused ones.

Several advantages are achieved by the method and apparatus according to the illustrative embodiments presented herein. The embodiments advantageously provide an improved apparatus and method for dispensing solder balls used in the fabrication of semiconductor devices. The improved apparatus and method advantageously dispenses solder balls having desired attributes, such as a desired diameter or a desired material or both on an on-demand basis, based on the production needs. Switching between solder balls having different attributes is enabled by switching containers containing the desired solder balls. Unused solder balls are advantageously retained in the container for future use, thereby advantageously protecting the solder balls from being exposed to the environment. The retention of the unused solder balls in the container improves production efficiency by reducing wastage, The dispensing of the solder balls advantageously occurs in a first-in-first-out (FIFO) sequence, thereby enabling timely utilization of the solder balls. That is, solder balls dispensed in the ball bin are utilized prior to the utilization of the solder balls still being dispensed through the nozzle. A controlled flow of the solder balls is advantageously achieved by balancing incoming flow of the solder balls through the tube and outgoing flow of the solder balls being placed by the pick-and-place machine to assemble the semiconductor device. The improved apparatus and method advantageously maintains compatibility with legacy the assembly line components by using the ball bin and the tool head of the legacy assembly line.

Although illustrative embodiments have been shown and described, a wide range of modification, change and substitution is contemplated in the foregoing disclosure and in some instances, some features of the embodiments may be employed without a corresponding use of other features. Those of ordinary skill in the art will appreciate that the hardware and methods illustrated herein may vary depending on the implementation. For example, while certain aspects of the present disclosure have been described in the context of dispensing solder balls, those of ordinary skill in the art will appreciate that the processes disclosed are capable of being used for assembly of semiconductor devices using discrete bulk commodity products.

The methods and systems described herein provide for an adaptable implementation. Although certain embodiments have been described using specific examples, it will be apparent to those skilled in the art that the invention is not limited to these few examples. The benefits, advantages, solutions to problems, and any element(s) that may cause any benefit, advantage, or solution to occur or become more pronounced are not to be construed as a critical, required, or an essential feature or element of the present disclosure.

The above disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. An apparatus comprising:
a container having an opening for dispensing solder balls, the solder balls having a common configurable solder ball diameter, the container being positioned to enable a flow of the solder balls through the opening;
a tube having a proximal opening and a distal opening, the proximal opening being coupled to the opening of the container; and
a nozzle coupled to the distal opening, the nozzle having a nozzle orifice configured in accordance with the solder ball diameter to dispense the solder balls.

2. The apparatus of claim 1 further comprising:
a hopper vibrator coupled to the nozzle, wherein the hopper vibrator is operable to impart vibration energy to the nozzle, thereby providing a stimulus to the flow; and
a sensor operable to detect a presence of the solder balls in the tube.

3. The apparatus of claim 2 further comprising:
a controller coupled to the sensor and the hopper vibrator, the controller being capable of controlling the hopper vibrator.

4. The apparatus of claim 3, wherein the controller disables the hopper vibrator in response to the sensor detecting an absence of the solder balls in the tube.

5. The apparatus of claim 1, wherein the tube is fabricated from a clear plastic.

6. The apparatus of claim 1, wherein a switch in the solder balls having a first attribute to the solder balls having a second attribute is made by a replacement of a first container containing the solder balls having the first attribute to a second container containing the solder balls having the second attribute, wherein unused ones of the solder balls having the first attribute is retained in the first container.

7. The apparatus of claim 1, wherein a rate of the flow of the solder balls is adjustable by making an adjustment to the nozzle diameter and by making an adjustment to an amount of vibration energy delivered to the nozzle.

8. The apparatus of claim 7, wherein the rate of the flow is adjusted to be equal to a rate of removal of the solder balls by a pick-and-place machine from a ball bin, wherein the ball bin is disposed under the nozzle to receive the solder balls.

9. The apparatus of claim 7, wherein the flow rate is adjusted by making an inclination angle of the nozzle to be approximately equal to 10 degrees, the inclination angle being formed between an axis of the nozzle and a horizontal direction,

10. The apparatus of claim 1, wherein the container is capable of being positioned in a container loading position and a solder ball dispensing position, wherein the container loading position enables a replacement of the container and disables the flow, wherein the solder ball dispensing position enables the dispensing of the solder balls, the flow being enabled by gravity.

11. The apparatus of claim 10, wherein the container is capable of being rotated around a pivot to be positioned in the container loading position and the solder ball dispensing position.

12. The apparatus of claim 1, wherein the solder balls are dispensed by the nozzle in a first-in-first-out sequence.

13. The apparatus of claim 1 further comprising:
a ball bin disposed under the nozzle to collect the solder balls dispensed from the nozzle orifice; and
a tool head to pick selected ones of the solder balls from the ball bin for an assembly of a semiconductor device.

14. The apparatus of claim 13 wherein the semiconductor device is at least one of a microprocessor, an application specific integrated circuit (ASIC), a digital signal processor, a radio frequency chip, a memory, a microcontroller and a system-on-a-chip or a combination thereof.

15. A method for dispensing solder balls, the method comprising:
positioning a container to enable a gravity-assisted flow of solder balls through an opening of the container, the container containing the solder balls having a common configurable solder ball diameter;
coupling a proximal end of a tube to the opening;
coupling a distal end of the tube to a nozzle; and
adjusting an inclination angle of the nozzle and an orifice of the nozzle to regulate the flow of the solder balls.

16. The method of claim 15 further comprising:
vibrating the nozzle to provide a stimulus to the flow;
collecting the solder balls in a ball bin disposed below the nozzle;
placing selected ones of the solder balls from the ball bin between conductive surfaces of an integrated circuit (IC) chip and a substrate; and
reflowing the selected ones of the solder balls to electrically and mechanically couple the conductive surfaces of the IC chip and the substrate to assemble a semiconductor device.

17. The method of claim 16 further comprising:
detecting an absence of the solder balls in the tube; and
disabling the vibrating in response to detecting the absence.

18. The method of claim 16 wherein the semiconductor device is at least one of a microprocessor, an application specific integrated circuit (ASIC), a digital signal processor, a radio frequency chip, a memory, a microcontroller and a system-on-a-chip or a combination thereof.

19. The method of claim 16 further comprising:
replacing the container by a new container; and
removing as scrap unused ones of the solder balls located outside the container.

20. The method of claim 19, wherein the replacing includes:
positioning the container for removal of a bottle included in the container, wherein unused ones of the solder balls are retained in the bottle;
sliding a base component of a metal frame of the container to enable the removal of the bottle;
removing the bottle containing the unused ones;
replacing the bottle by a new bottle placed on the base component;
sliding the base component to securely house the new bottle in the metal frame, the new container being formed by the new bottle housed in the metal frame;
positioning the new container for dispensing, the new container containing new solder balls; and
adjusting the nozzle orifice to match a size of the new solder balls.
